(19) United States
(12) Patent Application Publication
(10) Pub. No.: US 2026/0352388 A1
(43) Pub. Date: Nov. 5, 2026

(54) METHOD AND APPARATUS FOR SUPPORTING MULTIPLE TRANSMIT-RECEIVE POINT OPERATION IN WIRELESS COMMUNICATION SYSTEM

(71) Applicant: Samsung Electronics Co., Ltd., Gyeonggi-do (KR)

(72) Inventors: Deokhui LEE, Gyeonggi-do (KR); Dongmyung KIM, Gyeonggi-do (KR); Sooeun SONG, Gyeonggi-do (KR); Sangho LEE, Gyeonggi-do (KR); Jaehong YI, Gyeonggi-do (KR); Juho LEE, Gyeonggi-do (KR)

(21) Appl. No.: 19/101,769

(22) PCT Filed: Aug. 17, 2023
(86) PCT No.: PCT/KR2023/012210

§ 371 Date: Feb. 6, 2025

(30) Foreign Application Priority Data
Aug. 17, 2022 (KR) 10-2022-0102764

(51) Int. Cl. H04L 5/00; H04W 24/10; H04W 56/00; H04W 72/231

(52) U.S. Cl. CPC H04L 5/0035; H04L 5/0094; H04W 24/10; H04W 56/001; H04W 56/0055; H04W 72/231

(57) ABSTRACT

The present disclosure relates to a method and apparatus for supporting a multiple TRP operation in a wireless communication system. According to an embodiment of the present disclosure, the method for user equipment to support a multiple TRP operation in a wireless communication system comprises the steps of: receiving a first synchronization signal block (SSB) from a first TRP that is a serving TRP of the user equipment; receiving a second SSB from a second TRP that is a neighboring TRP of the first TRP; identifying a receive timing difference (RTD) between the first SSB and the second SSB; and if a measurement report event is triggered, transmitting, to the first TRP, a measurement report message including information indicating the RTD.

### TECHNICAL FIELD

The disclosure relates to a method and device related to operation of multiple TRPs in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DETAILED DESCRIPTION OF THE INVENTION

### Technical Problem

The disclosure provides a method and device for efficiently supporting a multiple-TRP operation in a wireless communication system.

The disclosure also provides a method and device for UE-based receive timing difference (RTD) measurement report in a wireless communication system supporting a multiple-TRP operation.

The disclosure also provides a method and device for base station (TRP)-based RTD measurement report in a wireless communication system supporting a multiple-TRP operation.

### Technical Solution

According to an embodiment of the disclosure, a method for supporting a multiple-TRP operation by a UE in a wireless communication system comprises receiving a first synchronization signal block (SSB) from a first TRP which is a serving TRP of the UE, receiving a second SSB from a second TRP which is a neighbor TRP of the first TRP, identifying a receive timing difference (RTD) between the first SSB and the second SSB, and transmitting a measurement report message including information indicating the RTD to the first TRP in case that a measurement report event is triggered.

The method may further comprise receiving a radio resource control (RRC) reconfiguration message adding the second TRP for the multiple-TRP operation from the first TRP in response to meeting an RTD limit.

In the method, in case that the RTD is smaller than a threshold, the RTD limit is met and, in case that the RTD is larger than the threshold, the second TRP is not added.

In the method, at least one of transmission periods and SSB indexes of the first SSB and the second SSB is the same.

In the method, the information indicating the RTD includes at least one of an RTD corresponding to an SSB index having a largest reception signal strength, an average RTD for a plurality of SSB indexes, and an RTD for a defined number of SSB indexes selected based on a signal strength or signal quality.

Further, according to an embodiment of the disclosure, a UE in a wireless communication system comprise a transceiver and a processor configured to receive, through the transceiver, a first SSB from a first TRP which is a serving TRP of the UE, receive, through the transceiver, a second SSB from a second TRP which is a neighbor TRP of the first TRP, identify a receive timing difference (RTD) between the first SSB and the second SSB, and transmit, through the transceiver, a measurement report message including information indicating the RTD to the first TRP in case that a measurement report event is triggered.

Further, according to an embodiment of the disclosure, a method for supporting a multiple-TRP operation by a serving TRP of a UE in a wireless communication system comprises transmitting, to a neighbor TRP of the serving TRP, a propagation delay measurement request message including information about a dedicated preamble available when measuring a propagation delay in a path between the UE and the neighbor TRP, allocating the dedicated preamble to the UE, receiving a report message including a propagation delay measurement result of a physical random access channel (PRACH) preamble from the neighbor TRP receiving the PRACH preamble from the UE, and determining whether to perform a multiple-TRP operation on the UE based on the received propagation delay measurement result.

In the method, the determining comprises identifying a first propagation delay in a path to the serving TRP from the UE, identifying a second propagation delay in a path to the neighbor TRP from the UE for the received propagation delay measurement result, and identifying a receive timing difference (RTD) between the first propagation delay and the second propagation delay.

The method further comprises determining that the RTD is valid in case that the RTD is smaller than a threshold and transmitting an RRC reconfiguration message adding the neighbor TRP to the UE for the multiple-TRP operation.

The method further comprises determining that the RTD is not valid in case that the RTD is larger than the threshold, and determining not to perform the multiple-TRP operation.

In the method, the dedicated preamble is used for propagation delay measurement related to configuration of the multiple-TRP operation.

Further, according to an embodiment of the disclosure, a serving TRP in a wireless communication system, the serving TRP comprises a transceiver, and a communication interface, and a processor configured to transmit, through the communication interface to a neighbor TRP of the serving TRP, a propagation delay measurement request message including information about a dedicated preamble available when measuring a propagation delay in a path between the UE and the neighbor TRP, allocate the dedicated preamble to the UE through the transceiver, receive, through the communication interface, a report message including a propagation delay measurement result of a PRACH preamble from the neighbor TRP receiving the PRACH preamble from the UE, and determine whether to perform a multiple-TRP operation on the UE based on the received propagation delay measurement result.

### BRIEF DESCRIPTION OF THE DRAWINGS

FIG. 1 is a view illustrating an example of a wireless communication system to which a multiple-TRP operation is applied according to an embodiment of the disclosure:

FIGS. 2A and 2B are views illustrating an example of receive timing difference (RTD) for determining whether a multiple-TRP operation is valid according to an embodiment of the disclosure;

FIG. 3 is a flowchart illustrating a UE-based RTD measurement report method in a wireless communication system supporting a multiple-TRP operation according to an embodiment of the disclosure:

FIG. 4 is a view illustrating a method performed in a UE in the embodiment of FIG. 3:

FIG. 5 is a view illustrating a method performed in a first TRP (serving TRP) in the embodiment of FIG. 3:

FIG. 6 is a flowchart illustrating a base station (TRP)-based RTD measurement report method in a wireless communication system supporting a multiple-TRP operation according to an embodiment of the disclosure;

FIG. 7 is a view illustrating a method performed in a UE in the embodiment of FIG. 6:

FIG. 8 is a view illustrating a method performed in a first TRP (serving TRP) in the embodiment of FIG. 6;

FIG. 9 is a view illustrating a method performed in a second TRP (neighbor TRP) in the embodiment of FIG. 6:

FIG. 10 is a view illustrating an example of a configuration of a UE in a wireless communication system according to an embodiment of the disclosure; and

FIG. 11 is a view illustrating an example of a configuration of a base station (TRP) in a wireless communication system according to an embodiment of the disclosure.

### MODE FOR CARRYING OUT THE INVENTION

Hereinafter, embodiments of the present invention are described in detail with reference to the accompanying drawings. When determined to make the subject matter of the present invention unclear, the detailed description of the known art or functions may be skipped. The terms as used herein are defined considering the functions in the present disclosure and may be replaced with other terms according to the intention or practice of the user or operator. Therefore, the terms should be defined based on the overall disclosure.

Advantages and features of the present disclosure, and methods for achieving the same may be understood through the embodiments to be described below taken in conjunction with the accompanying drawings. However, the present invention is not limited to the embodiments disclosed herein, and various changes may be made thereto. The embodiments disclosed herein are provided only to inform one of ordinary skilled in the art of the category of the present disclosure. The present invention is defined only by the appended claims. The same reference numeral denotes the same element throughout the specification.

It should be appreciated that the blocks in each flowchart and combinations of the flowcharts may be performed by computer program instructions.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card. According to embodiments, a “ . . . unit” may include one or more processors.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

As used herein, terms for identifying access nodes, terms denoting network entities, terms denoting messages, terms denoting inter-network entity interfaces, and terms denoting various pieces of identification information are provided as an example for ease of description. Thus, the disclosure is not limited by the terms, and such terms may be replaced with other terms denoting objects with equivalent technical concept.

In the disclosure, for convenience, the terms and names defined in the 3rd generation partnership project and defined in the 5G and NR standards are used. In embodiments of the disclosure, for convenience, an example of a 5G system is described, but embodiments of the disclosure are not limited by the terms and names in the 5G system, but may also be applied likewise to wireless communication systems according to other standards.

In the disclosure, the base station (BS) is a network entity allocating resources to the UE and capable of communicating with the UE and may be at least one of an eNode B, a Node B, a gNB, a radio access network (RAN), an access network (AN), a RAN node, an integrated access/backhaul (TAB) node, a radio access unit, a base station controller, a node over network, or a transmission reception point (TRP). The user equipment (UE) may be at least one of a terminal, a mobile station (MS), cellular phone, smartphone, computer, or multimedia system capable of performing communication functions.

Unlike conventional, the 5G system may support all of a service requiring a high transmission rate, a service having very short transmission latency, and a service requiring a high connection density. In a wireless communication network using a plurality of base stations, a plurality of cells, TRPs, or beams, cooperative communication (coordinated transmission) between base stations, cells, TRPs, and/or beams may increase the strength of the signal received by the UE and efficiently perform interference control between base stations, cells, TRPs, and/or beams to thereby meet various service requirements. For example, joint transmission (JT) using multiple TRPs is a representative transmission technology for cooperative communication, which increases the strength or throughput of the signal received by the UE by transmitting signals through multiple TRPs to the UE.

Further, in the 5G system, the synchronization signal block (SSB) is a physical layer signal block including a primary synchronization signal (PSS), a secondary synchronization signal (SSS), and a physical broadcast channel (PBCH). The base station may transmit one or more synchronization signal blocks (SSBs) within a time of 5 ms, and each SSB transmitted from the base station may be discerned by the SSB index. The UE may detect the PSS and SSS in the initial access phase and may decode the PBCH. The UE may obtain the master information block (MIB) from the PBCH and may be, through the MIB, configured with control resource set (CORESET) #0 (which may correspond to a control resource set having a control resource set index of 0). Further, the UE may perform monitoring on control resource set #0, assuming that the selected SSB and the demodulation reference signal (DMRS) transmitted in control resource set #0 are quasi-co-located (QCLed). The UE may receive system information as downlink control information transmitted in control resource set #0. The UE may obtain configuration information related to random access channel (RACH) required for initial access from the received system information. The UE may transmit the physical RACH (PRACH) to the base station considering the selected SSB index, and the base station receiving the PRACH may obtain information for the SSB index selected by the UE. The base station may know which SSB the UE has selected from the SSBs and monitors control resource set #0 related thereto.

Further, in the 5G system, beam management is to perform communication by selecting an optimal transmission/reception beam pair of transmission beam on the transmission side and reception beam on the reception side. In the initial cell search process, the UE may receive the SSB transmitted from the base station and, in this process, the base station may sequentially transmit a plurality of SSBs using a plurality of different transmission beams, and the UE may sequentially form a plurality of reception beams to measure the reception signal strength of each of the plurality of SSBs and find the optimal reception beam. The reception beam found in that way and the transmission beam having transmitted the corresponding SSB become an initial transmission/reception beam pair. If the initial transmission/reception beam pair is selected, an optimal transmission/reception beam pair may be determined through a beam adjustment procedure using CSI-RS.

In the disclosure, the SSB may be transmitted through the base station (e.g., TRP), and an SSB(s) having the same or different SSB indexes may be transmitted through a plurality of TRPs. In the case, when receiving SSB(s) from TRP(s), the UE may measure/identify the reception timing of each SSB and transmit information related to the reception timing measured for each SSB to the TRP serving the UE.

Further, in the disclosure, the TRP may provide higher layer signaling information (or configuration information) to the UE, and the higher layer signaling may be signaling corresponding to at least one, or a combination of one or more, of the following signaling.
Master information block (MIB)
SIB (System Information Block) or SIB X (X=1, 2, . . . )
Radio resource control (RRC)
Medium access control (MAC) control element (CE)

Further, in the disclosure, the TRP may provide L1 signaling information to the UE, and the L1 signaling information may be signaling corresponding to at least one, or a combination of one or more, of signaling methods using the following physical layer channel or signaling.
Physical downlink control channel (PDCCH)
Downlink control information (DCI)
UE-specific DCI
Group common DCI
Common DCI

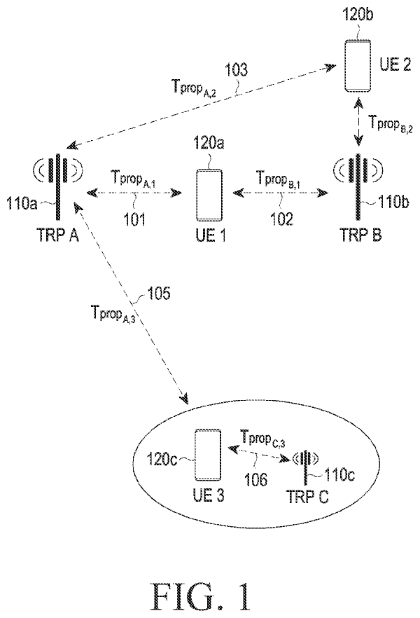

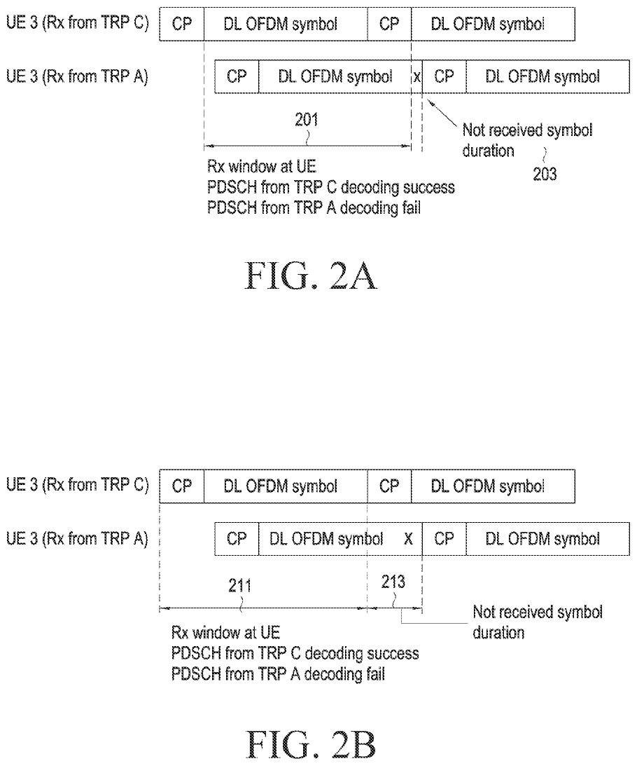

FIG. 1 is a view illustrating an example of a wireless communication system to which a multiple-TRP operation is applied according to an embodiment of the disclosure. FIGS. 2A and 2B are views illustrating an example of receive timing difference (RTD) for determining whether a multiple-TRP operation is possible according to an embodiment of the disclosure. Referring to FIGS. 2A and 2B, an example of FIG. 1 is described.

FIG. 1 illustrates an example of a network environment in which a plurality of TRPs (TRP A, TRP B. TRP C) 110a, 110b, and 110c, and a plurality of UEs (UE1, UE2, UE3) 120a, 120b, and 120c are present. At least two or more of the plurality of TRPs (TRP A, TRP B, TRP C) 110a, 110b, and 110c may transmit and receive signals to and from at least one of the plurality of UEs (UE1, UE2, UE3) 120a, 120b, and 120c through a multiple-TRP operation.

The plurality of TRPs (TRP A, TRP B, TRP C) 110a, 110b, and 110c may be connected to the same base station (e.g., gNB) or different base stations (e.g., gNBs). For example, TRP A and TRP B may be connected to the same base station, and TRP C may be connected to a different base station.

The multiple-TRP operation includes transmitting or receiving signals to/from the UE by multiple TRPs through cooperative communication, and an example thereof is joint transmission (JT) through multiple TRPs. If the receive timing difference (RTD) indicating a difference in propagation delays between multiple TRPs and UE is within a threshold, the multiple-TRP operation may be performed. The threshold may use, e.g., a cyclic prefix (CP) length of an orthogonal frequency division multiplexing (OFDM) symbol. The CP length is an example of the threshold, and the threshold may be provided in advance to the UE through configuration information by the serving TRP, or a value agreed in advance between the UE and the serving TRP may be used. In the disclosure, the serving TRP and the neighbor TRP may be the serving base station and a neighboring base station, or may be TRPs connected to the same gNB, or TRPs connected to different gNBs.

In the example of FIG. 1, a first RTD indicating the difference between the downlink (DL) propagation delay (Tprop_{A,1}) 101 between the TRP A 110a and the UE (UE1) 120a, and the DL propagation delay (Tprop_{B,1}) 102 between the TRP B 110b and the UE (UE1) 120a may be measured as ΔTprop_{UE1}=|Tprop_{A,1}−Tprop_{B,1}|. If the first RTD is significantly smaller than the CP length in the OFDM symbol (i.e., If RTD between multi-TRPs<<CP length), the multiple-TRP operations in which the TRP A 110a and the TRP B 110b cooperate to transmit DL signals to the UE (UE1) 120a may be stably performed.

In the example of FIG. 1, a second RTD indicating the difference between the DL propagation delay (Tprop_{A,2}) 101 between the TRP A 110a and the UE (UE2) 120b, and the DL propagation delay (Tprop_{B,2}) 102 between the TRP B 110b and the UE (UE2) 120b may be measured as ΔTprop_{UE2}=|Tprop_{A,2}−Tprop_{B,2}|. If the second RTD is within the CP length in the OFDM symbol (i.e., If RTD between multi-TRPs<CP Length), the multiple-TRP operation in which the TRP A 110a and the TRP B 110b cooperate to transmit the DL signal to the UE (UE2) 120a may be performed.

In the example of FIG. 1, a third RTD indicating the difference between the DL propagation delay (Tprop_{A,3}) 105 between the TRP A 110a and the UE (UE3) 120c, and the DL propagation delay (Tprop_{C,3}) 106 between the TRP C 110b and the UE (UE3) 120c may be measured as ΔTprop_{UE3}=|Tprop_{A,3}−Tprop_{C,3}|. If the third RTD is larger than the CP length in the OFDM symbol (i.e., If RTD between multi-TRPs>CP length), the multiple-TRP operation in which the TRP A 110a and the TRP C 10c cooperate to transmit the DL signal to the UE (UE3) 120c may be stably performed. In this case, referring to FIGS. 2A and 2B. FIG. 2A illustrates a case where the reception window (Rx window) 201 of the UE (UE3) 120c starts at the end of the CP, and FIG. 2B illustrates a case where the reception window (Rx window) 211 of the UE (UE3) 120c starts at the beginning of the CP. The OFDM symbol transmitted from TRP C 110b may be stably received in the reception window (Rx window) 201 of UE (UE3) 120c, but the OFDM symbol transmitted from TRP A 110a may not be stably received in the reception windows (Rx windows) 201 and 211 of UE (UE3) 120c due to the third RTD outside the CP length (203, 213).

In the disclosure, the UE may measure/identify the RTD between the multiple TRPs before the multiple-TRP operation is performed, and may transmit the RTD information to the serving TRP among the multiple TRPs. Based on the received RTD information, the serving TRP determines that the RTD between multiple TRPs is larger than the CP length as an invalid RTD, and prevents the multiple-TRP operation from being performed on the UE, and if the RTD between multiple TRPs is smaller than the CP length, determines the RTD as a valid RTD to allow the multiple-TRP operation to be performed on the UE. According to the disclosure, it is possible to efficiently determine whether a multiple-TRP operation is possible before the multiple-TRP operation in circumstances where a large RTD may be issued (for example, a circumstance in which the DL signal from one TRP is received in line of sight (LOS), and the DL signal from another TRP is received in non-LOS, a multiple-TRP scenario between macro cell and small cell, or a multiple-TRP scenario in which the UE moves at high speed).

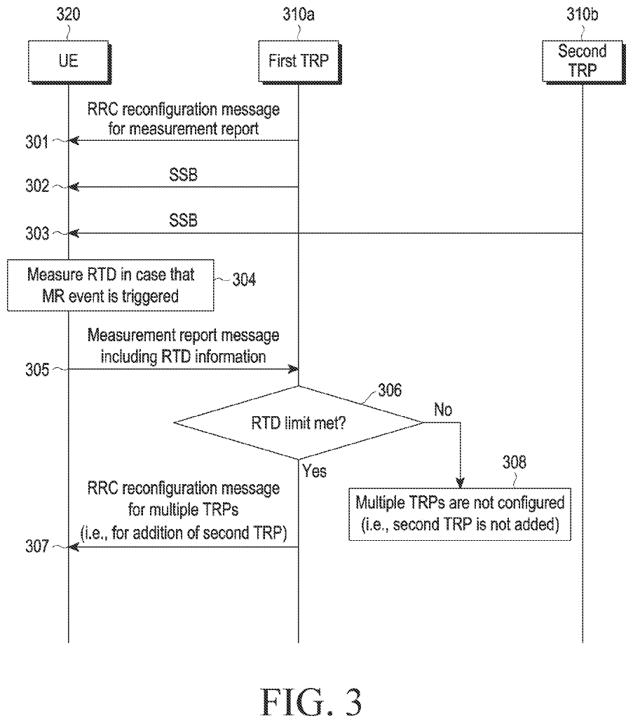

FIG. 3 is a flowchart illustrating a UE-based RTD measurement report method in a wireless communication system supporting a multiple-TRP operation according to an embodiment of the disclosure.

In the example of FIG. 3, the multi-TRP operation includes receiving, by the UE, a downlink (DL) signal from two or more TRPs. Proposed is a UE-based RTD measurement report method in which, before a multiple-TRP operation is performed, the UE 320 measures/identifies an RTD between multiple TRPs and reports it to the first TRP 310a operating as the serving TRP, the first TRP 310a determines whether to perform (whether to set) the multiple-TRP operation based on the measured/identified RTD information and, if the multiple-TRP operation is determined, the first TRP 310a and the second TRP 310b which is a neighbor base station cooperate to perform the multiple-TRP operation on DL.

Specifically, in step 301 of FIG. 3, the UE 320 receives an RRC reconfiguration message for measurement report related to multiple-TRP operation from the first TRP 310a.

In step 302, the UE 320 receives the first SSB from the first TRP 310a, and in this case, the UE 320 may measure/identify the reception timing of the first SSB.

In step 303, the UE 320 receives the second SSB from the second TRP 310b, and in this case, the UE 320 may measure/identify the reception timing of the second SSB.

In step 304, when a measurement report (MR) event is triggered, the UE 320 measures/identifies the RTD between the first TRP 310a and the second TRP 310b. Further, if a measurement report (MR) event is triggered in step 304, the UE 320 may measure reference signal received power (RSRP), reference signal received quality (RSRQ), or signal to interference noise ratio (SINR) for the first SSB and the second SSB.

In the embodiment of FIG. 3, RTD (i) representing RTD between the first TRP 310a, which is the serving TRP, and the second TRP 310b, which is a neighbor TRP, may be defined as in Equation 1 below.

T_{RTD}(i)=|T_{SSB,S}(i)−T_{SSB,N}(i)| [Equation 1]
T_{SSB,S}(i): Receive timing of i-th SSB of the serving TRP
T_{SSB,N}(i): Receive timing of i-th SSB of the neighbor TRP

In Equation 1, T_{SSB,S}(i) is the reception timing of the first SSB corresponding to the i-th SSB index received from the first TRP 310a, and T_{SSB,N}(i) is the reception timing of the second SSB corresponding to the i-th SSB index received from the second TRP 310b. In the above example of Equation 1, the definition of RTD assumes that the SSB transmission periods of the first TRP 310a and the second TRP 310b are the same, the physical cell IDs (PCIs) are different, and there is an overlapping SSB index.

Further, in relation to the above-described RTD measurement criteria, the UE 320 may measure the reception timing of receiving the synchronization signal (PSS/SSS) from each of the first TRP 310a and the second TRP 310b and measure the RTD indicating the difference between the reception timings.

If the SSB burst maps (=sb-PositionsInBurst IE) or SSB periodicities of the first TRP 310a and the second TRP 310b do not match, at least one SSB of the SSB index having the same position may be transmitted from the first TRP 310a and the second TRP 310b, respectively.

The ssb-PositionsInBurst IE represents the time domain position of the SSB transmitted in the half frame with the SS/PBCH block (i.e., SSB), as disclosed in TS 38.331. In the ssb-PositionsInBurst IE, the first/left bit corresponds to SSB index 0, and the second bit corresponds to SSB index 1. Further, in the ssb-PositionsInBurst IE, a value of 0 on the bitmap indicates that the SSB is not transmitted, and a value of 1 indicates that the SSB is transmitted.

As another example, when the condition in Equation 1 is not met or the SSB periodicity is different, the UE 320 may measure/identify the RTD through a modulo/shift operation.

For example, if the SSB periodicities (=ssb-periodicityServingCell IE) of the first TRP 310a and the second TRP 310b match, but there is no overlapping SSB index in the SSB burst map (=ssb-PositionsInBurst IE), referring to TS 38.213, section 4.1 Cell search, the SSB position and SSB index mapping method according to the subcarrier spacing length are described as shown in Table 1 below. Based on the method shown in Table 1 below, the UE 320 may know the time difference (which may be defined as T_{shift} in Equation 2 below) between SSB indexes for the SSB burst transmitted within the same SSB periodicity. For example, case C: It may be identified that at SCS=30 kHz w/FR1 (3.5 GHz), SSB indexes 0 and 1 differ by 6 symbols and SSB indexes 0 and 2 by 14 symbols. Therefore, when there is no overlapping SSB index in the SSB burst map (=ssb-PositionsInBurst IE), even if the first TRP 310a and the second TRP 310b transmit SSBs of different SSB indexes, the UE 320 may measure/identify RTD based on the time difference between SSB indexes.

TABLE 1
For a half frame with SS/PBCH blocks, the first symbol indexes
for candidate SS/PBCH blocks are determined according to the
SCS of SS/PBCH blocks as follows, where index 0 corresponds
to the first symbol of the first slot in a half-frame.

```

[symbol]
- 30 kHz SCS: the first symbols of the candidate SS/PBCH blocks
have indexes [symbol]
  For operations without [symbol] spectrum channel access
    For [symbol] spectrum [symbol]
      For carrier frequencies [symbol] than or equal to 3 GHz, [symbol] For carrier
      frequencies within FR1 larger than 3 GHz, [symbol]
    For [symbol] spectrum operation
      For carrier frequencies [symbol] or equal to [symbol] For carrier frequencies
      within FR1 larger than 2.3 GHz [symbol] [symbol]
indicates data missing or illegible when filed
```

For example, T_{RTD} (i, j) representing RTD between the first TRP 310a, which is the serving TRP, and the second TRP 310b, which is a neighbor TRP, may be defined as Equation 2 below when there is no overlapping SSB index (i.e., when the first TRP 310a and the second TRP 310b transmit SSBs of different SSB indexes).

T_{RTD}(i,j)=|T_{SSB,S}(i)−T_{SSB,N}(j)|+T_{shift} [Equation 2]
T_{SSB,S}(i): Receive timing of i-th SSB of the serving TRP
T_{SSB,N}(j): Receive timing of j-th SSB of the neighbor TRP
T_{shift}: time difference between i-th SSB and j-th SSB

In Equation 1, T_{SSB,S}(i) is the reception timing of the first SSB corresponding to the i-th SSB index received from the first TRP 310a, and T_{SSB,N}(j) is the reception timing of the second SSB corresponding to the j-th SSB index received from the second TRP 310b. T_{shift} is the time difference between the i-th and j-th SSB indexes (i.e., the time difference represented by the number of symbols between the starting symbol (first symbol) of the i-th SSB index and the starting symbol (first symbol) of the j-th SSB index)

Further, when the SSB periodicities (=ssb-periodicityServingCell IE) of the first TRP 310a and the second TRP 310b do not match, and there is no overlapping SSB index in the SSB burst map (=ssb-PositionsInBurst IE), even if the SSB periodicities are not the same, the candidate setting value of the configurable SSB periodicity is set in the form of a multiple, so that there is supposed to be a part where they overlap. Thus, even in this case, the UE 320 may measure/identify the RTD through a module operation using the multiple relationship (e.g., when the SSB periodicities of the first TRP 310a and the second TRP 310b are the least common multiple). In TS 38.331, the candidate setting values of the SSB periodicity are illustrated as multiples such as ssb-periodicityServingCell ENUMERATED {ms5, ms10, ms20, ms40, ms80, ms160, spare2, spare1}.

Referring back to the description of FIG. 3, in step 305, the UE 320 transmits a measurement report message including RTD information indicating the RTD measured/identified in step 304 to the first TRP 310a.

In step 306, the first TRP 310a receiving the RTD information determines/identifies whether the RTD related to the UE 320 meets the RTD limit. Specifically, the TRP 310a determines whether the RTD related to the UE 320 is within (smaller than) a threshold (e.g., the CP length) based on the RTD information.

When the RTD related to the UE 320 is smaller than the threshold in step 307, the TRP 310a determines/identifies that the RTD is valid, and transmits an RRC reconfiguration message for multiple TRPs (i.e., for the addition of the second TRP 310b) to the UE 320.

When the RTD related to the UE 320 is larger than the threshold in step 308, the first TRP 310a determines/identifies that the RTD is invalid, and does not configure multiple TRPs for the UE 320 (i.e., in this case, the second TRP 310b is not added).

Therefore, according to the above-described embodiment of FIG. 3, the UE measures/identifies the RTD between multiple TRPs before the multiple-TRP operation is performed, and the serving TRP may prevent the multiple-TRP operation from being performed to prevent DL performance degradation w % ben the RTD is larger than a predetermined threshold (e.g., the CP length). When the RTD is smaller than the predetermined threshold (e.g., the CP length), the serving TRP may stably perform a multi-TRP operation for transmitting a DL signal to the UE in cooperation with the neighbor TRP.

Meanwhile, in the disclosure, the RTD information may transmit as the T_{RTD} (i) value of Equation 1 or the T_{RTD} (i, j) value of Equation 2 as it is, or may be configured/transmitted in the following manner.

For example, the RTD information may be constituted of a plurality of bits or 1-bit information as in the following methods 1-1) and 1-2).

1-1) Multiple bits: A method for configuring RTD information with a number of bits representing the mapping index for each RTD range (e.g., Timing advanced in TS 38.211)

1-2) 1 bit: A method in which the UE configures 1-bit RTD information indicating whether multiple-TRP addition is possible (ok or not ok) considering SCS and CP type (normal or extended) after measuring RTD

Further, as an example, RTD information may be transmitted per SSB as shown in the methods shown in the following 2-1) to 2-3 (see the example of Table 2 below)

2-1) The method of transmitting the RTD corresponding to the best SSB index (the strongest reception signal) for the cell result included in the measurement report message in step 305 above

2-2) A method of taking and transmitting the average RTD for multiple SSB indexes for the cell result included in the measurement report message in step 305 above

2-3) Method of transmitting RTD for N best SSB indexes selected according to RSRP/RSRQ/SINR.

Further, e.g., the RTD information may be transmitted through the signaling/method shown in 3-1) to 3-3 below.

3-1) A method for transmitting RTD information through the addition of a new field in the conventional measurement report message and a method of including a configuration parameter for on/off setting of a corresponding multiple-TRP operation, where the measurement report (MR) trigger condition may use the A1/A2/ . . . event condition of the conventional method

3-2) A method of transmitting RTD information through uplink control information (UCI) or a method of transmitting RTD information through uplink MAC control element (UL MAC CE) by setting a target TRP for RTD measurement

3-3) Method of transmitting RTD information through msg3 that the UE transmits to the base station during random access of the UE

Meanwhile, in the disclosure, the target TRP (e.g., the second TRP 310b), which is an RTD measurement target, may be recognized/identified as in the following methods of 4-1) and 4-2.

4-1) A method of discerning the target TRP based on the PCI when the target TRP has a PCI different from that of the serving TRP (this is similar to the measurement report target being based on the PCI)

4-2) When the target TRP has the same PCI as the serving TRP,

4-2-1) A method of discerning by allocating different SSB indexes to the target TRP and the serving TRP, in which SSB indexes respectively used in the TRPs are allocated not to overlap. For example, a method in which in frequency range 1 (FR1) in the NR standard, up to eight SSBs (index=0, . . . , 7) are allocable, and the serving TRP uses index=0, . . . , 3, and the target TRP uses index=4, . . . , 7

4-2-2) When the SSB indexes allocated to the target TRP and the serving TRP overlap, in, e.g., FR1, up to eight SSBs (index=0, . . . , 7) are allocable and, if the serving TRP uses index=0, . . . , 3, and the target TRP uses index=0, . . . , 3, a method for discerning the TRPs is required, and the methods of 4-2-2-1) and 4-2-2-2) below may be supported.

4-2-2-1) A Method of including information (e.g., index) for discerning TRPs in the MIB (via PBCH), where the number of bits may be determined depending on the number of TRPs connectable to the base stations having the same PCI. When this method is used, a sequence is generated based on the information (e.g., index) when generating a PSS/SSS sequence in the SSB

4-2-2-2) A method for discerning the TRPs by making the resource position different in the frequency/time domain of the SSB. Here, in the frequency domain, the position of the SSB is set to differ using the absoluteFrequencySSB IE of Table 3 below in the RRC information and, in the time domain, the position of the SSB is set to differ using ssb-periodicityServingCell IE (i.e., ssb-periodicityServingCell ENUMERATED {ms5, ms10, ms20, ms40, ms80, ms160, spare2, spare1} in the RRC information

TABLE 3
AbsoluteFrequencySSB

Frequency of the SSB to be used for this serving cell. SSB related parameters (e.g. SSB index)
provided for a serving cell refer to this SSB frequency unless mentioned otherwise. The
cell-defining SSB of the PCell is always on the sync [symbol] Frequencies are considered to be on the
sync [symbol] if they are also identifiable with a GSCN value (see TS 38.101-1 [15]). If the field is absent,
the SSB related parameters should be absent, e.g. ssb-PositionsInBurst, ssb-periodicityServingCell
and subcarrierSpacing in ServingCellConfigCommon IE. If the field is absent, the UE obtains
timing reference from the SpCell. This is only supported in case the SCell is in the same
frequency band as the SpCell. [symbol]
indicates data missing or illegible when filed

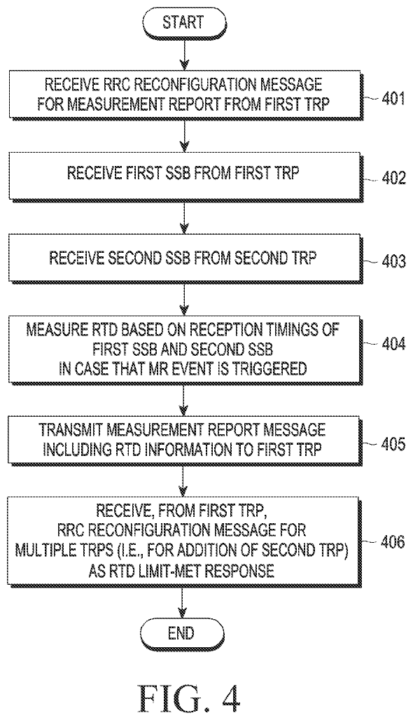

FIG. 4 is a view illustrating a method performed in a UE in the embodiment of FIG. 3.

In step 401 of FIG. 4, the UE 320 receives an RRC reconfiguration message for measurement report related to the multiple-TRP operation from the first TRP 310a.

The UE 320 receives the first SSB from the first TRP 310a in step 402, and the UE 320 receives the second SSB from the second TRP 310b in step 403. The first SSB and the second SSB may have the same SSB index or different SSB indexes as described above. Further, the first SSB and the second SSB may be received in the same SSB periodicity or in different SSB periodicities. Further, the UE 320 may receive the first SSB and the second SSB based on signaling information (RRC information, SIB, MAC CE, L1 signaling information, etc.) received from the first TRP 310a or the second TRP 310b, and may recognize/identify the second TRP 310b as a target TRP related to the multiple-TRP operation.

When the measurement report (MR) event is triggered in step 404, the UE 320 may measure/identify the RTD based on the reception timings of the first SSB and the second SSB. The RTD may be measured/identified using Equation 1 as described above, and the RTD information representing the RTD may be configured and transmitted using various methods as described above.

In step 405, the UE 320 transmits a measurement report message including the RTD information to the first TRP 310a. In step 406, the UE 320 receives an RRC reconfiguration message for multiple TRPs (i.e., for the addition of the second TRP 310b) from the first TRP 310a as an RTD limit-met response. The RTD limit-met response means a response in which the RTD is within a threshold (e.g., the CP length) in the UE 320.

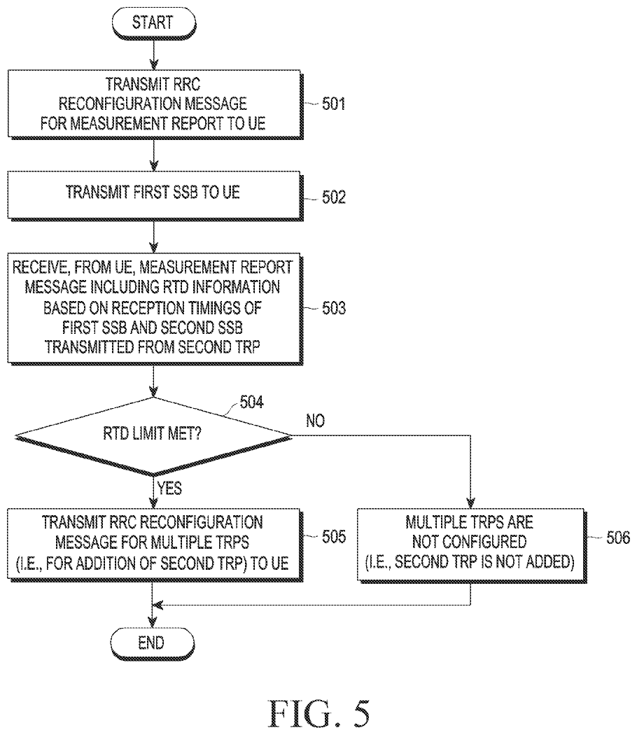

FIG. 5 is a view illustrating a method performed in a first TRP (serving TRP) in the embodiment of FIG. 3.

In step 501 of FIG. 5, the first TRP 310a transmits an RRC reconfiguration message for measurement report to the UE 320.

The first TRP 310a transmits the first SSB to the UE 320 in step 502.

In step 503, the first TRP 310a receives a measurement report message including RTD information based on the reception timings of the first SSB and the second SSB transmitted from the second TRP 310b from the UE.

In step 504, the first TRP 310a determines whether the RTD related to the UE 320 meets the RTD limit based on the RTD information. Specifically, the TRP 310a determines whether the RTD related to the UE 320 is within (smaller than) a threshold (e.g., the CP length) based on the RTD information.

In step 505, when the RTD related to the UE 320 is smaller than the threshold, the first TRP 310a determines/identifies that the RTD is valid, and transmits an RRC reconfiguration message for multiple TRPs (i.e., for the addition of the second TRP 310b) to the UE 320.

In step 506, when the RTD related to the UE 320 is larger than the threshold, the first TRP 310a determines/identifies that the RTD is invalid, and does not configure multiple TRPs for the UE 320 (i.e., in this case, the second TRP 310b is not added). When the RTD is equal to the threshold, it may be determined to be valid or invalid according to a setting.

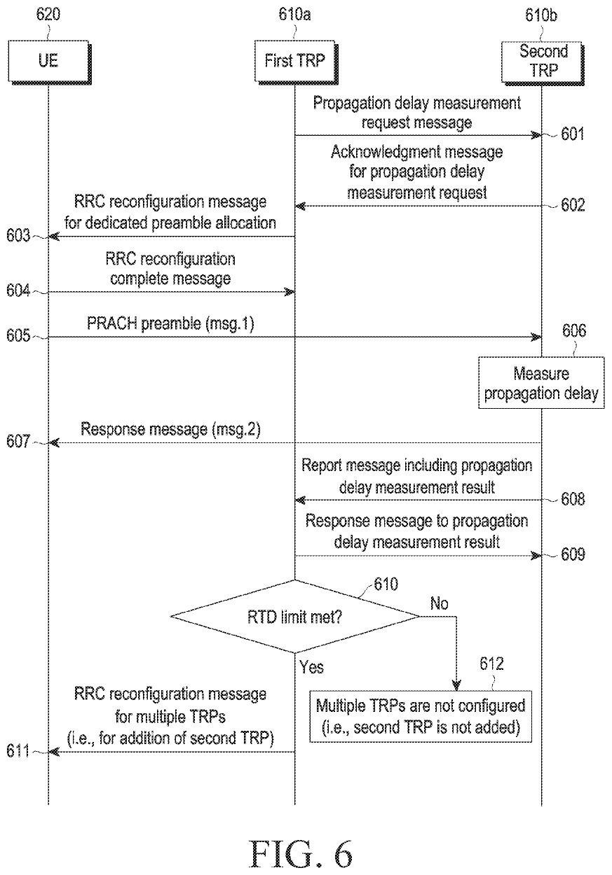

FIG. 6 is a flowchart illustrating a base station (TRP)-based RTD measurement report method in a wireless communication system supporting a multiple-TRP operation according to an embodiment of the disclosure.

In the example of FIG. 6, the multi-TRP operation includes transmitting, by the UE, an uplink (UL) signal to two or more TRPs. Before the multiple-TRP operation is performed, the first TRP 610a operating as the serving TRP transmits a measurement request to the second TRP 610b, which is a neighbor TRP, to determine whether the multiple-TRP operation is performed. Thereafter, the second TRP 620b receives the physical random access channel (PRACH) preamble from the UE 620 to measure the propagation delay, and transmits the measurement result to the first TRP 610a. The first TRP 610a measures/identifies an RTD defined as the difference between the first propagation delay in the path from the UE 620 to the first TRP 610a and the second propagation delay in the path from the UE 620 to the second TRP 620a, and determines whether to perform (whether to set) the multiple-TRP operation based on the RTD. The example of FIG. 6 proposes a base station (TRP)-based RTD measurement report method in which the first TRP 610a and the second TRP 620a cooperate to perform multiple-TRP operation on UL when the multiple-TRP operation is determined in the first TRP 610a as described above.

In an embodiment of FIG. 6, RTD indicating the T_{RTD} may be defined as in Equation 3 below.

T_{RTD}=|first propagation delay−second propagation delay| [Equation 3]
First propagation delay: Propagation delay between UE and serving TRP
Second propagation delay: Propagation delay between UE and neighbor TRP

In step 601 of FIG. 6, the first TRP 610a transmits a propagation delay measurement request message for a measurement request related to the multiple-TRP operation to the second TRP 610b. Here, the propagation delay measurement request message may include a dedicated preamble index that may be used to measure the propagation delay in the path between the UE 620 and the second TRP 610b. The dedicated preamble index may use at least one of dedicated preamble indexes that may be allocated in a contention free-based random access procedure.

In step 602, the first TRP 610a receives an acknowledgement message for the propagation delay measurement request from the second TRP 610b. The second TRP 610b may identify whether the dedicated preamble index received in step 601 is available in the second TRP 610b, and respond to the first TRP 610a through the acknowledgment message as to whether it is available in step 602.

In step 603, when the dedicated preamble index is available in the second TRP 610b, the first TRP 610a transmits an RRC reconfiguration message for allocating a dedicated preamble corresponding to the dedicated preamble index to the UE 620. In step 604, the first TRP 610a receives an RRC reconfiguration complete message from the UE 620 to which the dedicated preamble is allocated.

Thereafter, in step 605, the second TRP 610b receives a PRACH preamble corresponding to the dedicated preamble index from the UE 620. The PRACH preamble is transmitted through msg.1 in a random access procedure, for example. In this case, since the second TRP 610b has identified the dedicated preamble index in steps 601 and 602, it may recognize that the PRACH preamble is not for random access but for measuring propagation delay for multiple-TRP operation.

In step 606, the second TRP 620b measures the propagation delay (i.e., the second propagation delay) of the PRACH preamble in the path from the UE 620 to the second TRP 620a, and in step 607, the second TRP 620b transmits a response message (e.g., random access response (RAR) which is msg.2 in the random access procedure) to the UE 620.

In step 608, the first TRP 610a receives a report message including the measurement result of the second propagation delay from the second TRP 620b, and transmits a response message to the second TRP 620b in step 609.

In step 610, the first TRP 610a measures/identifies the RTD defined as the difference between the first propagation delay in the path from the UE 620 to the first TRP 610a and the second propagation delay in the path from the UE 620 to the second TRP 620a, and determines/identifies whether the RTD meets the RTD limit. Since the first TRP 610a is the serving TRP of the UE 620, the first TRP 610a may measure/identify the first propagation delay. In step 610, the first TRP 610a may determine whether the RTD limit is met based on whether the RTD is within a threshold. In the example of FIG. 6, as the threshold, the CP length may be used as in the example of FIG. 3, or a value preset not to cause performance degradation due to cross-link interference in the UL may be used.

When the RTD is smaller than the threshold in step 611, the first TRP 610a determines/identifies that the RTD is valid, and transmits an RRC reconfiguration message for multiple TRPs (i.e., for the addition of the second TRP 610b) to the UE 620.

When the RTD is larger than the threshold in step 612, the first TRP 610a determines/identifies that the RTD is invalid, and does not configure multiple TRPs for the UE 620 (i.e., in this case, the second TRP 610b is not added).

Therefore, according to the above-described embodiment of FIG. 3, the serving TRP measures/identifies the RTD between multiple TRPs before the multiple-TRP operation is performed, and the serving TRP may prevent the multiple-TRP operation from being performed to prevent UL performance degradation due to cross-link interference when the RTD is larger than a predetermined threshold. When the RTD is smaller than the predetermined threshold, the serving TRP may stably perform a multi-TRP operation for receiving a UL signal from the UE in cooperation with the neighbor TRP.

Meanwhile, when the first TRP 610a and the second TRP 620b are connected to the same base station (gNB) (or distributed unit (DU)) in the embodiment of FIG. 6, operations in steps 601, 602, 607, and 608 of FIG. 6 may be processed through the same base station (gNB), and thus, a procedure for transmitting and receiving corresponding messages between the first TRP 610a and the second TRP 620b may be omitted in this case.

Meanwhile, in the example of FIG. 6, the RTD may be represented using, e.g., a mapping index for each RTD range. (e.g., Timing advanced in TS 38.211)

Further, the target to which the first TRP 610a transmits the propagation delay measurement request message in step 601 of FIG. 6 may be determined by the methods of 5-1) and 5-2 below.
5-1) A method of unicast transmission to a specific TRP
5-2) A method of broadcast transmission to multiple TRPs

Further, the method of 5-2 may also be used when selecting UE-based multiple serving TRPs (for example, it may also be applied to ultra-dense network (UDN), cell-free networks, etc.).

Further, the propagation delay measurement request message in step 601 of FIG. 6 may include at least one piece of information among RACH-related information (i.e., rach-ConfigCommon setup IE as shown in Table 4 below) such as PRACH format, and dedicated preamble index, and the acknowledgment message for the propagation delay measurement request in step 602 may include at least one of RACH occasion (RO) mapping setting and SSB bit information. Further, in step 605 of FIG. 6, the UE 620 and the second TRP 610b may recognize that the PRACH preamble transmitted/received using the dedicated preamble index is for propagation delay measurement, not random access. The response message RAR is transmitted to the UE 620 in step 607 so that the retransmission operation of the PRACH preamble is not performed, and the UE 620 does not perform a separate additional operation after receiving the response message RAR. Further, information such as the dedicated preamble index, the propagation delay value, and the SSB index mapped to RACH occlusion (RO) which are the target for propagation delay measurement may be included in the report message including the measurement result of the second propagation delay in step 608 of FIG. 6. For the information element IE shown in Table 4 below, TS 38.331 may be referred to.

TABLE 4

```
rach-ConfigCommon setup:
  {
    rach-ConfigGeneric
    {
    prach-ConfigurationIndex,
    msg1-FDM,
    msg1-FrequencyStart,
    zeroCorrelationZoneConfig,
    preambleReceivedTargetPower,
    preambleTransMax,
    powerRampingStep,
    re-ResponseWindow
    },
    totalNumberOfRA-Preambles,
    ssb-RACH-OccasionAndCB-PreamblesPerSSB,
    re-ContentionResolutionTimer,
    rsrp-ThresholdSSB,
    prach-RootSequenceindex,
    msg1-SubcarrierSpacing,
},
ssb-PositionsInBurst mediumBitmap
ssb-peeriodicityServingCell,
ssbSubcarrierSpacing
```

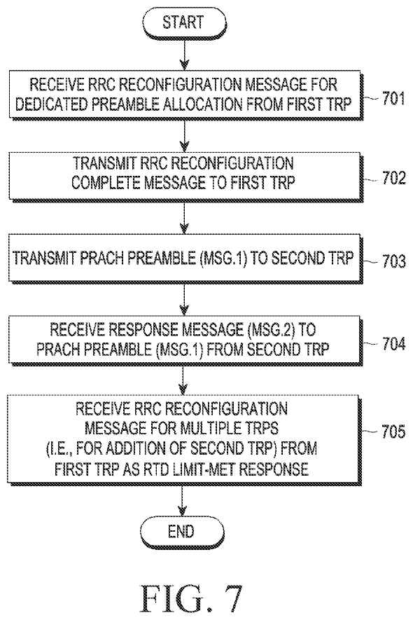

FIG. 7 is a view illustrating a method performed in a UE in the embodiment of FIG. 6.

In step 701 of FIG. 7, the UE 620 receives an RRC reconfiguration message for dedicated preamble allocation from the first TRP 610a. The RRC reconfiguration message may include an index of a dedicated preamble that may be used to measure the propagation delay in the path between the UE 620 and the second TRP 610b.

In step 702, the UE 620 to which the dedicated preamble is allocated transmits an RRC reconfiguration complete message to the first TRP 610a.

In step 703, the UE 620 transmits a PRACH preamble corresponding to the dedicated preamble index to the second TRP 610b.

In step 704, the UE 620 receives a response message (e.g., random access response (RAR) which is msg.2 in the random access procedure) to the transmission of the PRACH preamble from the second TRP 610b.

Thereafter, in step 705, according to the determination of the first TRP 610a, the UE 620 receives an RRC reconfiguration message for multiple TRPs (i.e., for the addition of the second TRP 610b) from the first TRP 610a as an RTD limit-met response.

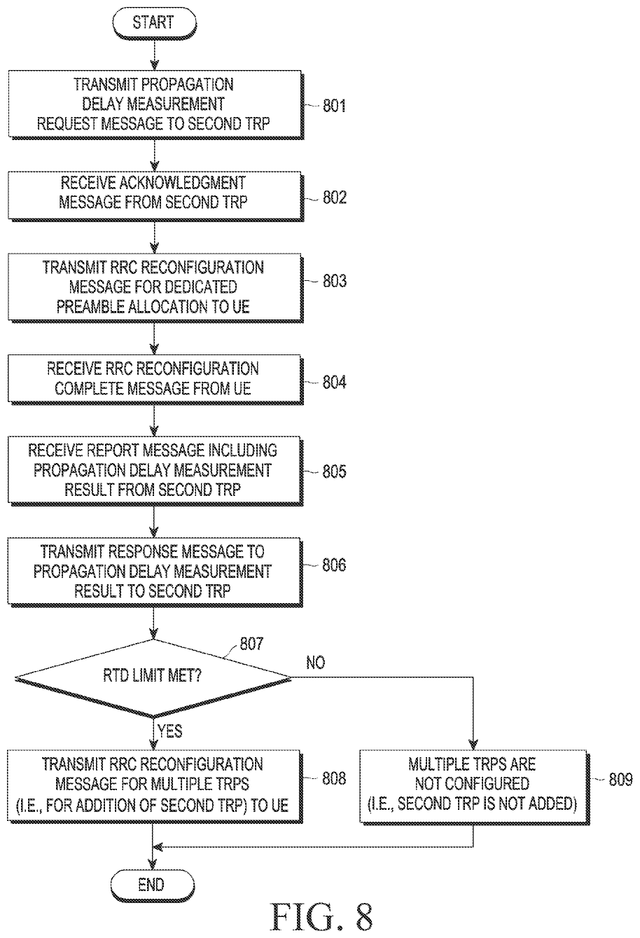

FIG. 8 is a view illustrating a method performed in a first TRP (serving TRP) in the embodiment of FIG. 6.

In step 801 of FIG. 8, the first TRP 610a transmits a propagation delay measurement request message to the second TRP 610b. The propagation delay measurement request message may include a dedicated preamble index that may be used to measure the propagation delay in the path between the UE 620 and the second TRP 610b.

In step 802, the first TRP 610a receives an acknowledgment message for the propagation delay measurement request from the second TRP 610b. The acknowledgment message may include information indicating that the dedicated preamble index is available in the second TRP 610b.

In step 803, the first TRP 610a transmits an RRC reconfiguration message for dedicated preamble allocation to the UE 620. The RRC reconfiguration message may include the dedicated preamble index. In step 804, the first TRP 610a receives an RRC reconfiguration complete message from the UE 620 to which the dedicated preamble is allocated.

In step 805, the first TRP 610a receives a report message including a propagation delay measurement result from the second TRP 610b that has received the PRACH preamble corresponding to the dedicated preamble index from the UE 620. The propagation delay measurement result is a measurement result of the propagation delay (i.e., the second propagation delay) of the PRACH preamble in the path from the UE 620 to the second TRP 620a.

In step 806, the first TRP 610a transmits a response message to the report message including the propagation delay measurement result to the second TRP 610b.

In step 807, the first TRP 610a measures/identifies the RTD defined as the difference between the first propagation delay in the path from the UE 620 to the first TRP 610a and the second propagation delay in the path from the UE 620 to the second TRP 620a, and determines/identifies whether the RTD meets the RTD limit. Since the first TRP 610a is the serving TRP of the UE 620, the first TRP 610a may measure/identify the first propagation delay.

When the RTD is smaller than the threshold in step 808, the first TRP 610a determines/identifies that the RTD is valid, and transmits an RRC reconfiguration message for multiple TRPs (i.e., for the addition of the second TRP 610b) to the UE 620.

When the RTD is larger than the threshold in step 809, the first TRP 610a determines/identifies that the RTD is invalid, and does not configure multiple TRPs for the UE 620 (i.e., in this case, the second TRP 610b is not added).

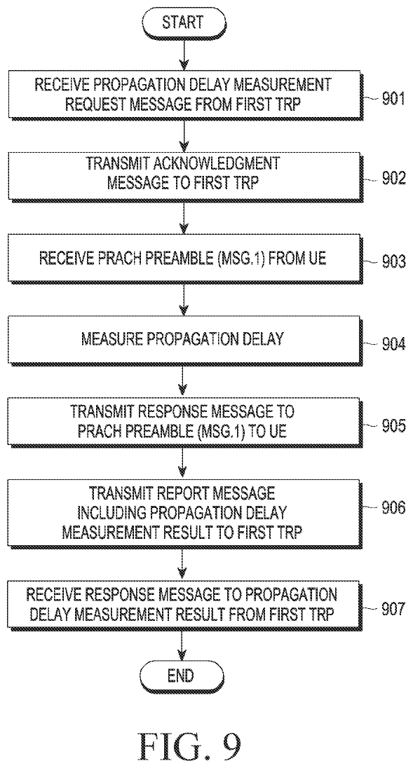

FIG. 9 is a view illustrating a method performed in a second TRP (neighbor TRP) in the embodiment of FIG. 6.

In step 901 of FIG. 9, the second TRP 610b receives a propagation delay measurement request message including a dedicated preamble index that may be used to measure propagation delay in the path between the UE 620 and the second TRP 610b from the first TRP 610a.

In step 902, the second TRP 610b transmits an acknowledgement message to the first TRP 610a. The second TRP 610b may identify whether the dedicated preamble index received in step 901 is available in the second TRP 610b, and respond to the first TRP 610a through the acknowledge response message as to whether it is available in step 902.

Thereafter, in step 903, the second TRP 610b receives the PRACH preamble from the UE to which the dedicated preamble corresponding to the dedicated preamble index is allocated.

In step 904, the second TRP 610b measures the propagation delay (i.e., the second propagation delay) of the PRACH preamble in the path from the UE 620 to the second TRP 620a, and in step 905, the second TRP 620b transmits a response message (e.g., random access response (RAR) which is msg.2) to the UE 620.

In step 906, the second TRP 620b transmits a report message including the measurement result of the second propagation delay to the first TRP 610a, and in step 907, receives a response message to the report message from the first TRP 610a. Thereafter, when the multiple-TRP operation is determined in the first TRP 610a, the second TRP 620a performs the multiple-TRP operation on UL in cooperation with the first TRP 610a.

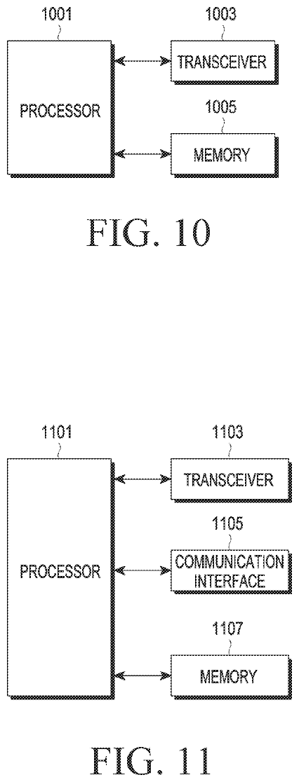

FIG. 10 is a view illustrating an example of a configuration of a UE in a wireless communication system according to an embodiment of the disclosure.

In FIG. 10, a UE may include a processor 1001, a transceiver 1003, and memory 1005. The processor 1001, transceiver 1003, and memory 1005 of the UE of FIG. 7 may be operated according to the method(s) described above in connection with FIGS. 1 to 9. However, the components of the UE are not limited thereto. For example, the UE may include more or fewer components than the above-described components. The processor 1001, the transceiver 1003, and the memory 105 may be implemented in the form of at least one chip.

The transceiver 1003 collectively refers to a receiver and a transmitter and may transmit and receive signals to/from a UE or another network entity. The transmitted/received signals may include at least one of control information and data. To that end, the transceiver 1003 may include an RF transmitter for frequency-up converting and amplifying signals transmitted and an RF receiver for low-noise amplifying signals received and frequency-down converting the frequency of the received signals. This is merely an embodiment of the transceiver 1003, and the components of the transceiver 1003 are not limited to the RF transmitter and the RF receiver. Further, the transceiver 1003 may receive signals through a communication scheme defined in the 3GPP standard, output the signals to the processor 1001, and transmit the signals output from the processor 1001. Further, the transceiver 1003 may receive the signal and output it to the processor 1001 and transmit the signal output from the processor 1001 to another network entity through the network. The memory 1005 may store programs and data necessary for the operation of the UE according to at least one of the embodiments of FIGS. 1 to 9. The memory 1005 may store control information and/or data that is included in the signal obtained by the UE. The memory 1005 may include a storage medium, such as ROM, RAM, hard disk, CD-ROM, and DVD, or a combination of storage media. The processor 1001 may control a series of processes so that the UE may operate according to at least one of the embodiments of FIGS. 1 to 9. The processor 1001 may include at least one processor.

FIG. 11 is a view illustrating an example of a configuration of a TRP (or base station) in a wireless communication system according to an embodiment of the disclosure.

Referring to FIG. 11, a TRP (or base station) may include a processor 1101, a transceiver 1103, a communication interface 1105, and memory 1107. The processor 1101, transceiver 1103, communication interface 1105, and memory 1105 of the TRP may be operated according to the method(s) described above in connection with FIGS. 1 to 9. However, the components of the TRP are not limited thereto. For example, the TRP may include more or fewer components than the above-described components. The processor 1101, the transceiver 1103, the communication interface 1105, and the memory 1105 may be implemented in the form of at least one chip.

The transceiver 1103 collectively refers to a receiver and a transmitter and may transmit and receive signals to/from a UE over a wireless network. Further, the TRP (or base station) may transmit and receive signals to/from another network entity (e.g., another TRP (or base station)) through the communication interface 1105 over a wired network or a wireless network. The signals transmitted/received through the transceiver 1103 or the communication interface 1105 may include at least one of control information and data. Further, the transceiver 1103 and the communication interface 1105 may receive signals through a communication scheme defined in the 3GPP standard, output the signals to the processor 1101, and transmit the signals output from the processor 1101 to another network entity. The memory 1105 may store programs and data necessary for the operation of the TRP according to at least one of the embodiments of FIGS. 1 to 9. Further, the memory 1105 may store control information and/or data that is included in the signal obtained by the network entity. The memory 1105 may include a storage medium, such as ROM, RAM, hard disk, CD-ROM, and DVD, or a combination of storage media. The processor 1101 may control a series of processes so that the TRP may operate according to at least one of the embodiments of FIGS. 1 to 9. The processor 1001 may include at least one processor.

The methods according to the embodiments descried in the specification or claims of the disclosure may be implemented in hardware, software, or a combination of hardware and software. When the processor 1001 or 1101 is implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in random access memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Or, the programs may be stored in memory constituted of a combination of all or some thereof. As each constituting memory, multiple ones may be included. The programs may be stored in attachable storage devices that may be accessed via a communication network, such as the Internet, Intranet, local area network (LAN), wide area network (WAN), or storage area network (SAN) or a communication network configured of a combination thereof. The storage device may connect to the device that performs embodiments of the disclosure via an external port. A separate storage device over the communication network may be connected to the device that performs embodiments of the disclosure.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Although specific embodiments of the present invention have been described above, various changes may be made thereto without departing from the scope of the present invention. Thus, the scope of the disclosure should not be limited to the above-described embodiments, and should rather be defined by the following claims and equivalents thereof.

1. A method for supporting a multiple-transmission reception point (TRP) operation by a user equipment (UE) in a wireless communication system, the method comprising:
receiving a first synchronization signal block (SSB) from a first TRP which is a serving TRP of the UE;
receiving a second SSB from a second TRP which is a neighbor TRP of the first TRP;
identifying a receive timing difference (RTD) between the first SSB and the second SSB; and
transmitting a measurement report message including information indicating the RTD to the first TRP in case that a measurement report event is triggered.

2. The method of claim 1, further comprising receiving a radio resource control (RRC) reconfiguration message adding the second TRP for the multiple-TRP operation from the first TRP in response to meeting an RTD limit.

3. The method of claim 2, wherein in case that the RTD is smaller than a threshold, the RTD limit is met, and
in case that the RTD is larger than the threshold, the second TRP is not added.

4. The method of claim 1, wherein at least one of transmission periods or SSB indexes of the first SSB and the second SSB are the same.

5. The method of claim 1, wherein the information indicating the RTD includes at least one of:
an RTD corresponding to an SSB index having a largest reception signal strength,
an average RTD for a plurality of SSB indexes, or
an RTD for a defined number of SSB indexes selected based on a signal strength or a signal quality.

6. A user equipment (UE) in a wireless communication system, comprising:
a transceiver; and
a processor configured to:
receive, through the transceiver, a first synchronization signal block (SSB) from a first transmission reception point (TRP) which is a serving TRP of the UE;
receive, through the transceiver, a second SSB from a second TRP which is a neighbor TRP of the first TRP;
identify a receive timing difference (RTD) between the first SSB and the second SSB; and
transmit, through the transceiver, a measurement report message including information indicating the RTD to the first TRP in case that a measurement report event is triggered.

7. (canceled)

8. A method for supporting a multiple-transmission reception point (TRP) operation by a serving TRP of a user equipment (UE) in a wireless communication system, the method comprising:
transmitting, to a neighbor TRP of the serving TRP, a propagation delay measurement request message including information about a dedicated preamble available when measuring a propagation delay in a path between the UE and the neighbor TRP;
allocating the dedicated preamble to the UE;
receiving a report message including a propagation delay measurement result of a physical random access channel (PRACH) preamble from the neighbor TRP receiving the PRACH preamble from the UE; and
determining whether to perform a multiple-TRP operation on the UE based on the received propagation delay measurement result.

9. The method of claim 8, wherein the determining comprises:
identifying a first propagation delay in a path to the serving TRP from the UE;
identifying a second propagation delay in a path to the neighbor TRP from the UE for the received propagation delay measurement result; and
identifying a receive timing difference (RTD) between the first propagation delay and the second propagation delay.

10. The method of claim 9, further comprising:
determining that the RTD is valid in case that the RTD is smaller than a threshold; and
transmitting a radio resource control (RRC) reconfiguration message adding the neighbor TRP to the UE for the multiple-TRP operation.

11. The method of claim 10, further comprising:
determining that the RTD is not valid in case that the RTD is larger than the threshold; and
determining not to perform the multiple-TRP operation.

12. The method of claim 8, wherein the dedicated preamble is used for propagation delay measurement related to configuration of the multiple-TRP operation.

13. A serving transmission reception point (TRP) in a wireless communication system, the serving TRP comprising:
a transceiver; and
a communication interface; and
a processor configured to:
transmit, through the communication interface to a neighbor TRP of the serving TRP, a propagation delay measurement request message including information about a dedicated preamble available when measuring a propagation delay in a path between the UE and the neighbor TRP;
allocate the dedicated preamble to the UE through the transceiver;
receive, through the communication interface, a report message including a propagation delay measurement result of a physical random access channel (PRACH) preamble from the neighbor TRP receiving the PRACH preamble from the UE; and
determine whether to perform a multiple-TRP operation on the UE based on the received propagation delay measurement result.

14. (canceled)

15. The serving TRP of claim 13, wherein the processor is further configured to:
identify a first propagation delay in a path to the serving TRP from the UE;
identify a second propagation delay in a path to the neighbor TRP from the UE for the received propagation delay measurement result; and
identify a receive timing difference (RTD) between the first propagation delay and the second propagation delay.

16. The serving TRP of claim 15, wherein the processor is further configured to:
determine that the RTD is valid in case that the RTD is smaller than a threshold; and
transmit, to the UE through the transceiver, a radio resource control (RRC) reconfiguration message adding the neighbor TRP for the multiple-TRP operation.

17. The serving TRP of claim 16, wherein the processor is further configured to:
determine that the RTD is not valid in case that the RTD is larger than the threshold; and
determine not to perform the multiple-TRP operation.

18. The serving TRP of claim 13, wherein the dedicated preamble is used for propagation delay measurement related to configuration of the multiple-TRP operation.

19. The UE of claim 6, wherein the processor is further configured to:
receiving, through the transceiver from the first TRP, a radio resource control (RRC) reconfiguration message adding the second TRP for the multiple-TRP operation in response to meeting an RTD limit.

20. The UE of claim 19, wherein in case that the RTD is smaller than a threshold, the RTD limit is met, and
in case that the RTD is larger than the threshold, the second TRP is not added.

21. The UE of claim 6, wherein at least one of transmission periods or SSB indexes of the first SSB and the second SSB are the same.

22. The UE of claim 6, wherein the information indicating the RTD includes at least one of:
an RTD corresponding to an SSB index having a largest reception signal strength,
an average RTD for a plurality of SSB indexes, or
an RTD for a defined number of SSB indexes selected based on a signal strength or a signal quality.
